(19) United States
(12) Patent Application Publication
(10) Pub. No.: US 2005/0195911 A1
(43) Pub. Date: Sep. 8, 2005

(54) Communication system

(75) Inventor: Bo Deng, Lincoln, NE (US)

Correspondence Address: SUITER WEST SWANTZ PC LLO, 14301 FNB PARKWAY, SUITE 220, OMAHA, NE, 68154, US

(73) Assignee: Cellaxon Co.

(21) Appl. No.: 11/119,560

(22) Filed: May 2, 2005

Related U.S. Application Data
(62) Division of application No. 09/689,415, filed on Oct. 12, 2000.
(60) Provisional application No. 60/159,337, filed on Oct. 13, 1999.
(60) Provisional application No. 60/178,780, filed on Jan. 28, 2000.
(60) Provisional application No. 60/209,646, filed on Jun. 6, 2000.
(60) Provisional application No. 60/222,354, filed on Aug. 1, 2000.

(51) Int. Cl. H04L 5/12

(52) U.S. Cl. 375/261

(57) ABSTRACT

A data communication system is disclosed utilizing a transmitter and one or more receivers. The communication system may increase the data rate without requiring an increase in bandwidth. Additional advantages include an inexpensive encryption property, the incorporation of a simple adaptive synchronization scheme, and the incorporation of an effective error detection and error correction scheme allowing for increased noise and signal degradation.

### CROSS REFERENCES TO RELATED APPLICATIONS

The present application is a non-provisional patent application claiming priority under 35 U.S.C. 119 to the following U.S. provisional patent applications: 60/159,337 filed Oct. 13, 1999; 60/178,780 filed Jan. 28, 2000; 60/209,646 filed Jun. 6, 2000; and 60/222,354 filed Aug. 1, 2000. The present application incorporates said before mentioned four provisional patent applications by reference herein in their entirety.

### FIELD OF THE INVENTION

The present invention relates generally to electronic communication, and more specifically to coding schema, synchronization schema, demodulation schema, bandwidth efficiency schema, error detection/correction schema, and encryption schema.

### BACKGROUND OF THE INVENTION

Communication systems and methods known to the art utilize a number of digital modulation techniques. Digital modulation techniques known to the art generally encode information by relating the information in different combinations in amplitude, frequency, and phase to a radio frequency carrier. Digital modulation techniques known to the art may include amplitude shift keying, frequency shift keying, phase shift keying, and combinations of the like such as quadrature modulation. In order to decode the modulated signal, receivers need to generate waveform synchronous to the carrier before information can be recovered by applying Fourier expansion/transformation techniques to the modulated signal.

With differing types of coding/decoding, carrier/symbol synchronization, and error detection/correction, current communication systems and methods may become extremely complex, which in turn, may require very high processing power. In particular, requiring high precision synchrony to the signal carrier and symbol timing by the receivers usually leads to highly complex synchronization circuits.

Other limitations of current communication systems known to the art is the inability to provide secure communication, free from eavesdropping, without incorporating an encryption system with the system.

Consequently, it would be advantageous if a system and method of communication existed not requiring specialized circuitry for carrier/symbol synchronization. It would also be advantageous if a system and method of communication existed which required little or minimum circuitry for error detection/correction. It would also be advantageous if a system and method of communication existed which included an inexpensive way to encrypt/decrypt data. Further, it would be advantageous (for the purpose of increasing channel bandwidth efficiency) if a communication system and method existed for which the operations of carrier/symbol synchronization, data extraction, and error detection/correction were all accomplished by essentially one combined operation which were also robust in the presence of noise and signal degradation.

### SUMMARY OF THE INVENTION

Accordingly, the present invention is directed to a communication system and method combining carrier/symbol synchronization, data extraction, error detection/correction in essentially one robust operation, thus significantly reducing receiver's circuit complexity. The system and method of communication of the present invention may include encryption attributes within the system and method.

It is to be understood, both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1 depicts a block diagram of an exemplary embodiment of the communication system of the present invention;

FIG. 2 depicts an exemplary input signal and an exemplary corresponding output signal from a spike burster of the present invention showing an activation and deactivation region, which are determined and controlled by input signal's derivative, and the corresponding output voltage spikes from a spike burster;

FIG. 3 is another exemplary input signal and an exemplary output signal from a spike burster of the present invention showing an activation and deactivation region, which are determined and controlled by input signal's amplitude, and the corresponding output voltage spikes from a spike burster;

FIG. 4(a) depicts an exemplary embodiment of a signal's-derivative-controlled spike burster of the present invention showing a voltage input source, a capacitor, and a non-linear resistive network in series;

FIG. 4(b) depicts an exemplary current-voltage operating curve for a non-linear resistive network of an exemplary embodiment of signal's-derivative-controlled spike burster of the present invention shown in FIG. 4(a);

FIG. 4(c) depicts an exemplary embodiment of a signal's-derivative-controlled spike burster of the present invention showing a current input source, an inductor, and a non-linear resistive network in parallel;

FIG. 4(d) depicts an exemplary current-voltage operating curve for a non-linear resistive network of an exemplary embodiment of signal's-derivative-controlled spike burster of the present invention shown in FIG. 4(c);

FIG. 5(a) depicts an exemplary embodiment of a signal's-amplitude-controlled spike burster of the present invention showing a voltage input source, an inductor, and a non-linear resistive network in series;

FIG. 5(b) depicts an exemplary current-voltage operating curve for a non-linear resistive network of an exemplary embodiment of signal's-amplitude-controlled spike burster of the present invention shown in FIG. 5(a);

FIG. 5(c) depicts an exemplary embodiment of a signal's-amplitude-controlled spike burster of the present invention showing a current input source, a capacitor, and a non-linear resistive network in parallel;

FIG. 5(d) depicts an exemplary current-voltage operating curve for a non-linear resistive network of an exemplary embodiment of signal's amplitude-controlled spike burster of the present invention shown in FIG. 5(c);

FIG. 6 depicts an exemplary embodiment of a derivative-controlled spike burster portion of a receiver of the present invention showing the schematic for an exemplary embodiment of the present invention;

FIG. 7 depicts an exemplary embodiment of an amplitude-controlled spike burster portion of a receiver of the present invention showing the schematic for an exemplary embodiment of the present invention;

FIG. 8(a) depicts another exemplary input signal to, and exemplary output signal from, an exemplary embodiment of a signal's-derivative-controlled spike burster of the present invention as measured utilizing an oscilloscope showing arbitrary-shaped input waveforms;

FIG. 8(b) depicts another exemplary input signal with noise added to, and exemplary output signal from, an exemplary embodiment of a spike burster of the present invention as measured utilizing an oscilloscope;

FIG. 9 depicts an exemplary input signal to, and exemplary output signal from, an exemplary embodiment of a spike burster of the present invention as measured utilizing an oscilloscope illustrating actual input to, and output from, an exemplary embodiment of a signal's-amplitude-controlled spike burster;

FIG. 10(a) depicts an exemplary embodiment of derivative-controlled activation and deactivation regions of an exemplary four spike burster receiver system of the present invention;

FIG. 10(b) depicts another exemplary embodiment of derivative-controlled activation and deactivation regions of an exemplary four spike burster receiver system of the present invention highlighting spike burster one's activation and deactivation region;

FIG. 10(c) depicts another alternative embodiment of derivative-controlled activation and deactivation regions of an exemplary four spike burster receiver system of the present invention highlighting spike burster two's activation and deactivation region;

FIG. 11 depicts an input signal to, and an output signal from, an exemplary embodiment of a four spike burster receiver system of the present invention showing the outputs of the respective spike bursters when the input signal in each's derivative-controlled activation region and deactivation region;

FIG. 12(a) depicts an exemplary embodiment of amplitude-controlled activation and deactivation regions of an exemplary four spike burster receiver system of the present invention;

FIG. 12(b) depicts another exemplary embodiment of amplitude-controlled activation and deactivation regions of an exemplary four spike burster receiver system of the present invention highlighting spike burster one's activation and deactivation region;

FIG. 12(c) depicts another alternative embodiment of amplitude-controlled activation and deactivation regions of an exemplary four spike burster receiver system of the present invention highlighting spike burster two's activation and deactivation region;

FIG. 13 depicts an input signal to, and an output signal from, an exemplary embodiment of a four spike burster receiver system of the present invention showing the outputs of the respective spike bursters when the input signal in each's amplitude-controlled activation region and deactivation region;

FIG. 14(a) depicts an exemplary sinusoid input signal to and an exemplary corresponding output signal from a spike burster of the present invention showing information is coded by the amplitude of the sinusoidal input signal and information is represented by the number of spikes of the output signal when the spike burster is in activation;

FIG. 14(b) depicts an exemplary sinusoid input signal to and an exemplary corresponding output signal from a spike burster of the present invention showing information is coded by the frequency of the sinusoidal input signal and information is represented by the number of spikes of the output signal when the spike burster is in activation;

FIG. 14(c) depicts an exemplary sinusoid input signal to and an exemplary corresponding output signal from a spike burster of the present invention showing information is coded by the phase of the sinusoidal input signal and information is represented by the number of spikes of the output signal when the spike burster is in activation;

FIG. 14(d) depicts an exemplary sinusoid input signal to and an exemplary corresponding output signal from a spike burster of the present invention showing information is coded by the modulated amplitude of the sinusoidal input signal and information is redundantly represented by the number of spikes of the output signal when the spike burster is in activation;

FIG. 14(e) depicts an exemplary sinusoid input signal to and an exemplary corresponding output signal from a spike burster of the present invention showing information is coded by the modulated frequency of the sinusoidal input signal and information is redundantly represented by the number of spikes of the output signal when the spike burster is in activation;

FIG. 14(f) depicts an exemplary sinusoid input signal to and an exemplary corresponding output signal from a spike burster of the present invention showing information is coded by the modulated phase of the sinusoidal input signal and information is represented by the number of spikes of the output signal when the spike burster is in activation and during the phase changes;

FIG. 15 depicts an exemplary sinusoid input signal to and two exemplary corresponding output signals from spike burster(s) of the present invention showing information is coded by the modulated phase of the sinusoidal input signal and information is represented by the burst initiation times of the output signal;

FIG. 16 depicts an exemplary sinusoid input signal to and two exemplary corresponding output signals from spike burster(s) of the present invention showing information is coded by the modulated amplitude and phase of the sinusoidal input signal and the bit information in phase is represented by the burst initiation times of the output signal;

FIG. 17 illustrates a 16 state-point quadrature amplitude modulation polar coordinate diagram (QAM constellation) wherein the efficiency of the present invention is illustrated;

FIGS. 18(a) and 18(b) illustrate more preferred constellations and the increased bandwidth efficiency of some embodiments of the present invention:

FIG. 19 depicts an exemplary embodiment of a spike burster utilized to create part of a spike burster receiver systems within the present invention;

FIG. 20 depicts an exemplary embodiment of a coder utilized to code data for transmission within the present invention; and

FIG. 21 depicts an exemplary embodiment of an adaptive counter circuit of the present invention.

### DETAILED DESCRIPTION OF THE INVENTION

Reference will now be made in detail to a presently preferred embodiment of the invention, an example of which is illustrated in the accompanying drawings.

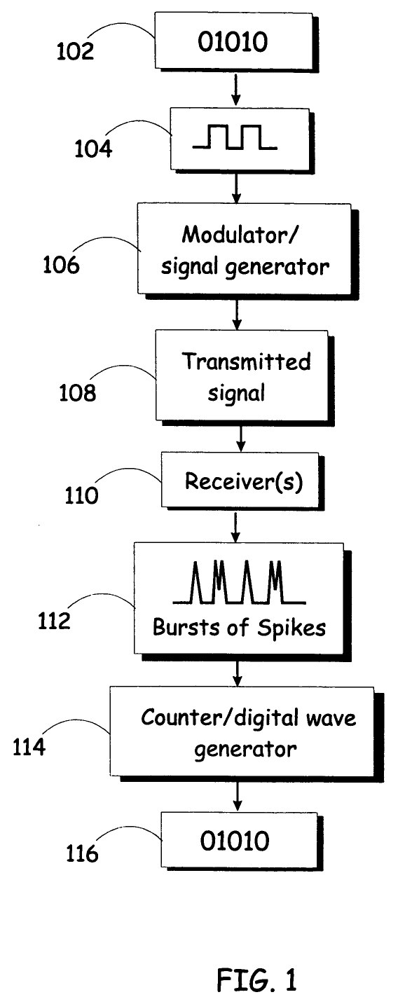

FIG. 1 generally depicts a block diagram of an exemplary embodiment of the present invention. In FIG. 1, a digital number 01010 may be inputted 102 into the system of the present invention. A digital signal representation 104 of the digital sequence 01010 is shown. The digital representation 104 then may enter a modulator/signal generator 106. The modulator/generator 106 may be constructed to modulate the signal many different ways including amplitude modulation, frequency modulation, phase modulation, frequency shift keying, and the like. The modulated signal may then be transmitted 108 over a particular medium. The particular medium may include wired or wireless transmission. The transmitted modulated signal 108 is received at the receiver(s) 110. The receiver(s) 110 are designed such that all spike burster activation regions together cover the entire area in which the transmitted modulated signal 108 may lie. When the voltage or current of a signal entering a spike burster lies inside a burst activation region, as defined by the circuitry of the spike burster, the spike burster outputs a pulse stream or spike burst. A spike burster's activation region is a range of voltages or currents of the input signal or the derivative of the input signal which causes the spike burster to output spikes. By using more than one spike burster, it is possible to decode more than one bit per wavelength. The receiver(s) 110 may convert the transmitted modulated signal to voltage or current spikes 112. Each spike burster may output a predetermined number of voltage or current spikes when the transmitted modulated signal 108 is within the spike burster's activation region. For example, the output spike 112 signals may be summed using a summing operational amplifier or the burst timing may be recorded by a threshold or duty cycle timer and then converted to the final number 116 with a digital wave generator or counter 114.

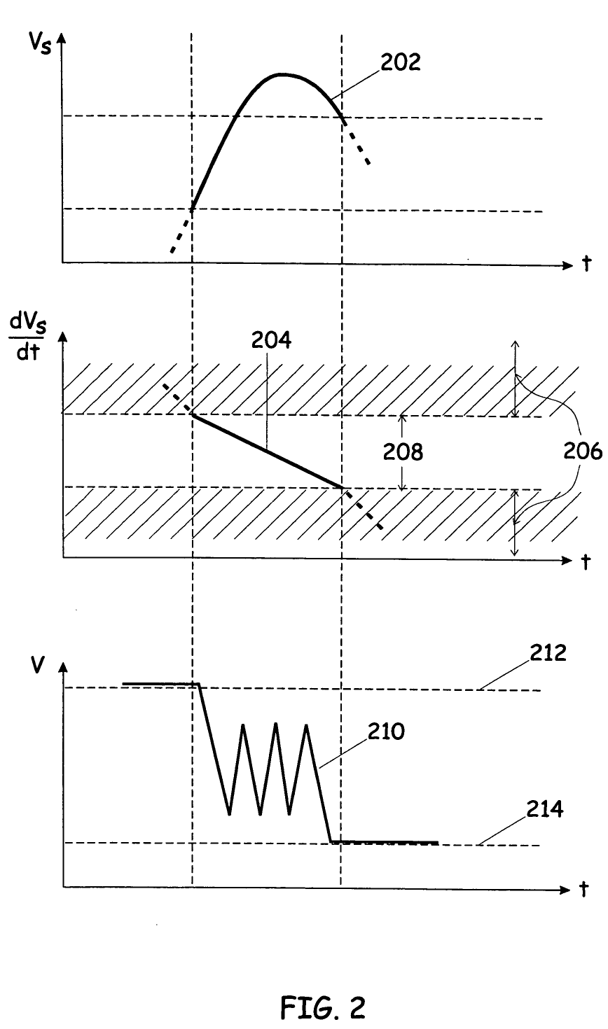

FIG. 2 shows an exemplary transmitted modulated signal 202 as a function of voltage in time and the corresponding output voltage spikes 210 from a spike burster. Typical deactivation regions 206 and activation regions 208 of the spike burster are determined by the derivative 204 of the signal 202. The activation region may be only a fraction of one wavelength in length. Since the transmitted modulated signal 302 may enter more than one activation region every wavelength, more than one bit may be decoded per wavelength. The spike burster may output voltage spikes 210 when the transmitted modulated signal 202 is within the activation region 208. FIG. 2 shows the output of voltage spikes 210 while the transmitted modulated signal 202 is in the activation region 208. Current spikes from the spike burster may also be used.

The number of voltage spikes 210 outputted by a spike burster may be limited to a particular set of numbers of voltage spikes 210 using, for example, a counter and clipper circuit. Each spike burster may then output a known number of voltage spikes each time the transmitted modulated signal enters the spike burster's activation region. The output voltage 210 has a near-constant maximum voltage 212 and a near-constant minimum voltage 214 when the transmitted modulated wave 202 is not in the activation region 208 and is in the deactivation region 206 of the spike burster.

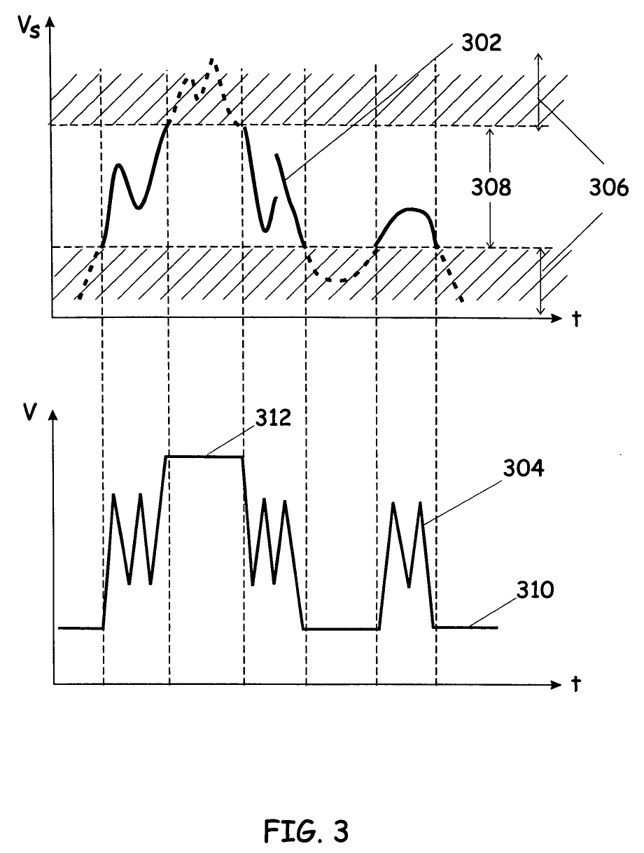

FIG. 3 shows another exemplary transmitted modulated signal 302 and the corresponding output voltage spikes 304 from the spike burster. Again similar to the case of signal's derivative-controlled spike bursters as of FIG. 2, the transmitted modulated signal 302 may enter more than one activation region every wavelength, more than one bit may be decoded per wavelength. An exemplary deactivation region 306 and activation region 308 are shown. The spike burster outputs voltage spikes 304 when the transmitted modulated signal 302 may be located within the activation region 308, and outputs a near-constant, lower voltage 310 or a near-constant, higher voltage 312 when the transmitted modulated signal 302 is located in the spike burster's deactivation region 306. Current spikes from the spike burster may be used, as well as voltage spikes. Since the input signal's profile (shape, form) is not limited in order to cause a spike burster to output burst of spikes, and since activation and deactivation regions can be arbitrarily specified for a spike burster, information embedded to a transmitting signal may be made secure because only that spike burster may output correct spike bursts representing the message.

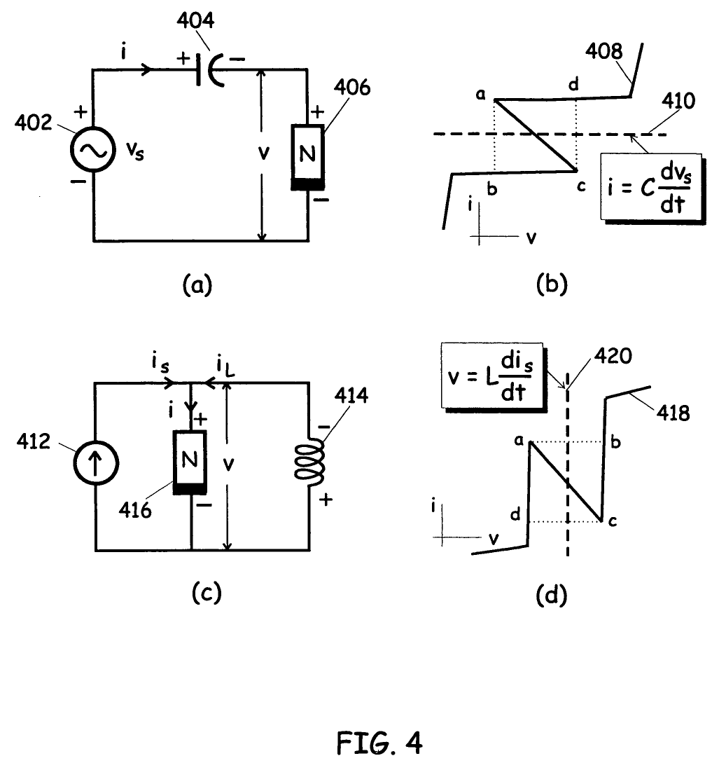

FIG. 4(a) depicts an exemplary circuit type of signal's-derivative-controlled spike burster. An input voltage source 402 is in series with a capacitor 404 and a non-linear resistive network 406 whose current-voltage operating curve has an exemplary shape of 408. The load line 410 is controlled by the input source's derivative. The signal input 402 enters the spike burster's activation region when the load line 410 cuts across the negative resistant branch of the current-voltage operating curve 408. The voltage spikes move from point b to point c on 408 when in its upward swing and from point d to point a on 408 when in its downward swing. The current spikes move from point c to point d when in its upward swing and from point a to point b when in its downward swing. Together, the operating point in the voltage and the current move around the cycle abcd during spike burster activation. The signal input 402 enters the spike burster's deactivation region when the load line 410 cuts across the positive resistant branches of the current-voltage operating curve 408. When the load line 410 cuts either of the near-vertical branches of 408, the voltage output reaches either a near-constant maximum value such as 212 or a near-constant minimum value such as 214 of FIG. 2.

FIG. 4(c) depicts another exemplary circuit type of signal's-derivative-controlled spike burster. An input current source 412 is in parallel with an inductor 414 and in parallel with a non-linear resistive network 416 whose current-voltage operating curve has an exemplary shape of 418. The load line 420 is controlled again by the input current source's derivative. The signal input 412 enters the spike burster's activation region when the load line 420 cuts across the negative resistant branch of the current-voltage operating curve 418. The voltage spikes move from point c to point d when in its downward swing and from point a to point b when in its upward swing. The current spikes move from point d to point a on 418 when in upward swing and from point b to point c on 418 when in its downward swing. Together, the operating point in the voltage and the current move around the cycle abcd during spike burster activation. The signal input 412 enters the spike burster's deactivation region when the load line 410 cuts across the positive resistant branches of the current-voltage operating curve 418. When the load line 420 cuts either of the near-horizontal branches of 418, the current output reaches either a near-constant maximum value such as 212 or a near-constant minimum value such as 214 of FIG. 2.

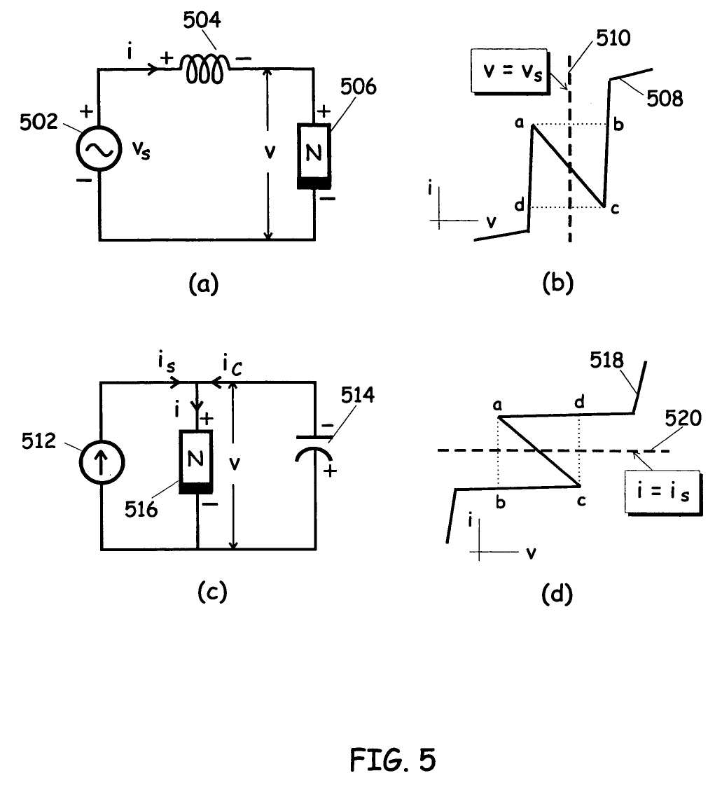

FIG. 5(a) depicts an exemplary circuit type of signal's-amplitude-controlled spike burster. An input voltage source 502 is in series with an inductor 504 and a non-linear resistive network 506 whose current-voltage operating curve has an exemplary shape of 508. The load line 510 is controlled by the input voltage source's amplitude. The signal input 502 enters the spike burster's activation region when the load line 510 cuts across the negative resistant branch of the current-voltage operating curve 508. The voltage spikes move from point c to point d when in its downward swing and from point a to point b when in its upward swing. The current spikes move from point d to point a on 518 when in its upward swing and from point b to point c on 518 when in its downward swing. Together, the operating point in the voltage and the current move around the cycle abcd during spike burster activation. The signal input 502 enters the spike burster's deactivation region when the load line 510 cuts across the positive resistant branches of the current-voltage operating curve 508. When the load line 510 cuts either of the near-horizontal branches of 508, the current output reaches either a near-constant maximum value such as 212 or a near-constant minimum value such as 214 of FIG. 2.

FIG. 5(c) depicts another exemplary circuit type of signal's-amplitude-controlled spike burster. An input current source 512 is in parallel with a capacitor 514 and in parallel with a non-linear resistive network 516 whose current-voltage operating curve has an exemplary shape of 518. The load line 520 is controlled again by the input current source's amplitude. The signal input 512 enters the spike burster's activation region when the load line 520 cuts across the negative resistant branch of the current-voltage operating curve 518. The voltage spikes move from point b to point c on 518 when in its upward swing and from point d to point a when in its downward swing. The current spikes move from point c to point d, when in its upward swing and from point a to point b when in its downward swing. Together, the operating point in the voltage and the current move around the cycle abcd during spike burster activation. The signal input 512 enters the spike burster's deactivation region when the load line 520 cuts across the positive resistant branches of the current-voltage operating curve 518. When the load line 520 cuts either of the near-vertical branches of 518, the voltage output reaches either a near-constant maximum value such as 212 or a near-constant minimum value such as 214 of FIG. 2.

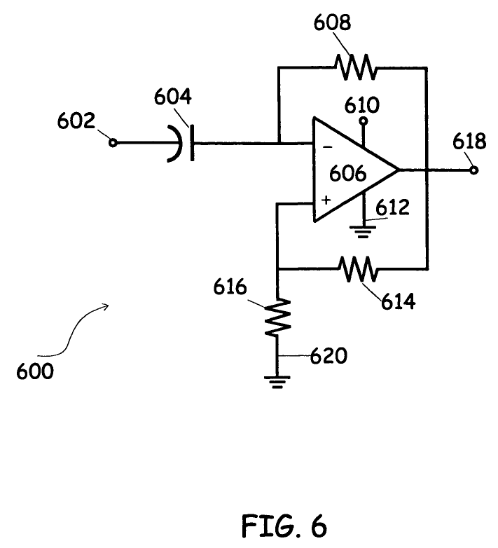

FIG. 6 depicts an exemplary embodiment of a circuit which may be utilized as a spike burster portion of a receiver controlled by signal's derivative. By adjusting the values of the individual components, the activation region and deactivation region of the spike burster may be adjusted. More than one spike burster 600 may be used at the same time to decode a transmitted modulated signal 602. For example, the input 602 is where a transmitted modulated signal enters the spike burster 600. The capacitor 604 is connected to the negative input of an operational amplifier 606. Also connected to the negative input of the operational amplifier is a negative feedback resistor 608. Again the negative feedback resistor 608 may be adjusted to vary the activation region of the spike burster 600. The power voltage connected to the positive power input 610 of the operational amplifier 606 defines the amplitude of the output voltage spikes. The value of the power voltage 610 will be the maximum amplitude of the output voltage spikes. The negative power input 612 to the operational amplifier 606 is connected to ground 620. A positive feedback resistor 614 is connected from the positive input of the operational amplifier 606 to the output 618 of the spike burster 600. Again the value of the positive feedback resistor 614 may be adjusted to vary the activation region of the spike burster 600. The ground resistor 616 is connected to the positive input to the operational amplifier 606 and to ground 620. The output 618 of the spike burster 600 is where the voltage spikes are outputted to the rest of the receiver.

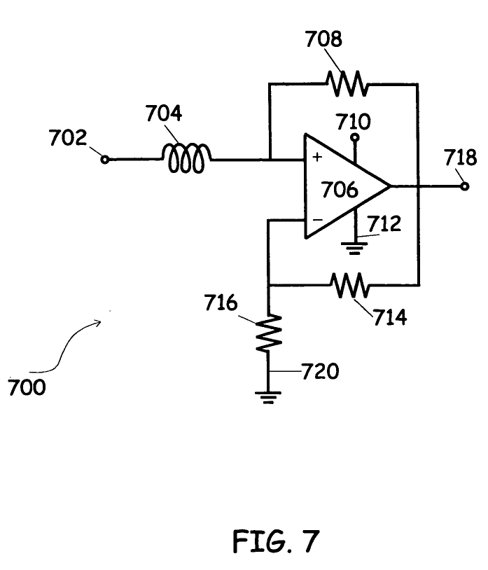

FIG. 7 depicts an exemplary embodiment of a spike burster circuit which is controlled by signal's amplitude. The input 702 is where a transmitted modulated signal enters the spike burster 700. The inductor 704 is connected to the positive input of an operational amplifier 706. Also connected to the positive input of the operational amplifier is a negative feedback resistor 708. Again the negative feedback resistor 708 may be adjusted to vary the activation region of the spike burster 700. The negative power input 712 to the operational amplifier 706 is connected to ground 720. A positive feedback resistor 714 is connected from the negative input of the operational amplifier 706 to the output 718 of the spike burster 700. Again the value of the positive feedback resistor 714 may be adjusted to vary the activation region of the spike burster 700. The ground resistor 716 is connected to the negative input to the operational amplifier 706 and to ground 720. The output 718 of the spike burster 700 is where the voltage spikes are outputted to the rest of the receiver.

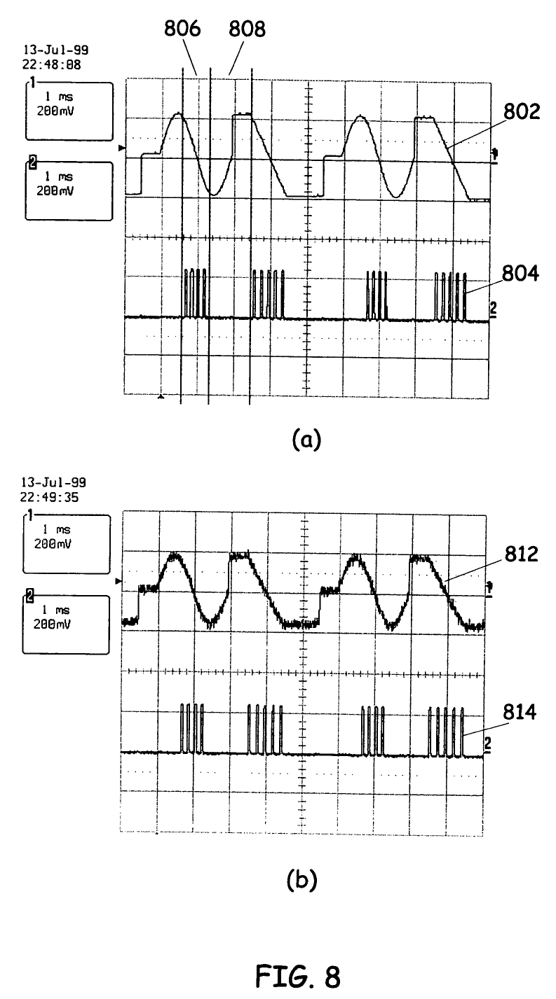

FIG. 8(a) shows an exemplary screen printout from an oscilloscope with an input wave 802 that includes a combination of distinctly-shaped waves. The input wave to the receiver(s) need not be sinusoidal in character. The corresponding output 804 is shown for a spike burster 600 with the following values: the capacitor 604 is 10 nanofarads; the operational amplifier 606 is National Semiconductor's part number LM 358; the value of the negative feedback resistor 608 is 1000 ohms: the value of the power voltage 610 to the operational amplifier 606 is 1.6 volts; the value of the positive feedback resistor 612 is 10 ohms; the value of the ground resistor 616 is 100 ohms. The activation region 806 of this spike burster is negative edge triggered and lasts until the slope of the input signal 802 is non-negative (either positive or zero slope). The deactivation region 810 is non-negative edge triggered and lasts until the slope of the input signal 802 is negative. The output 804 of this spike burster outputs spikes while the input signal 802 has a negative slope. The output 804 has a constant low voltage when the input signal 802 has a non-negative slope.

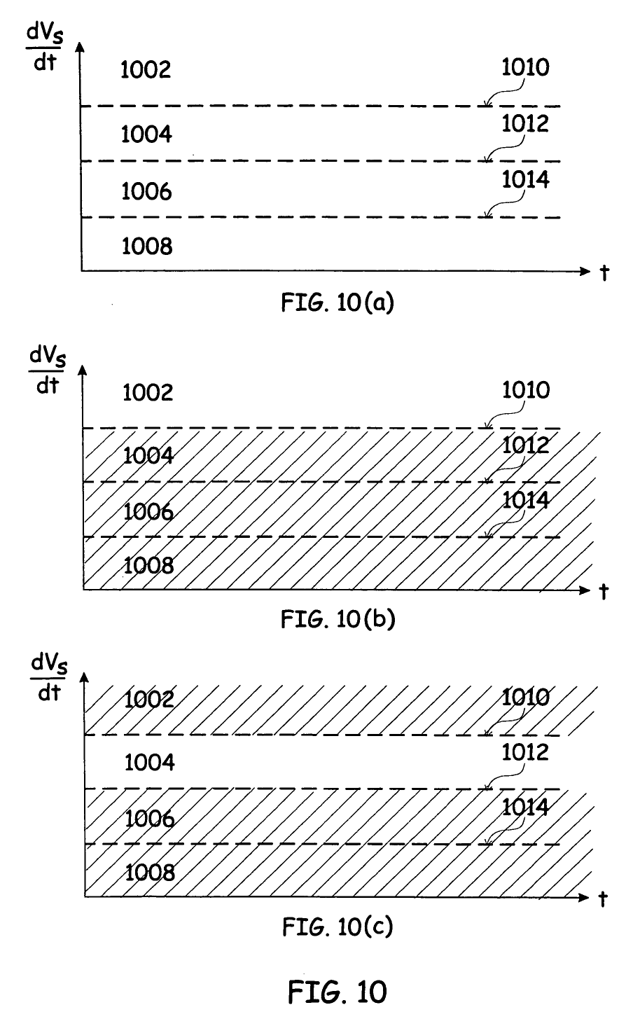

FIG. 8(b) shows the same input signal 802 as in FIG. 8(a) with noise added to the input 802. With the present invention, the spike burster will still output the same voltage spikes 812 even with a significant amount of noise added to the input signal 802. The activation boundary of 808 may be raised or lowered by changing the values of the individual components as shown in FIGS. 10, 11 and 19.

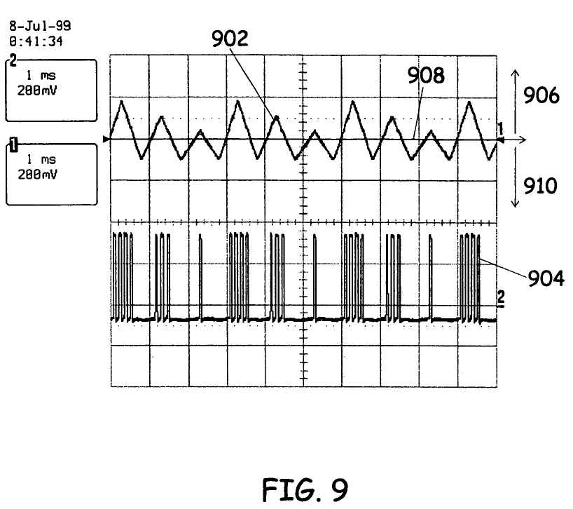

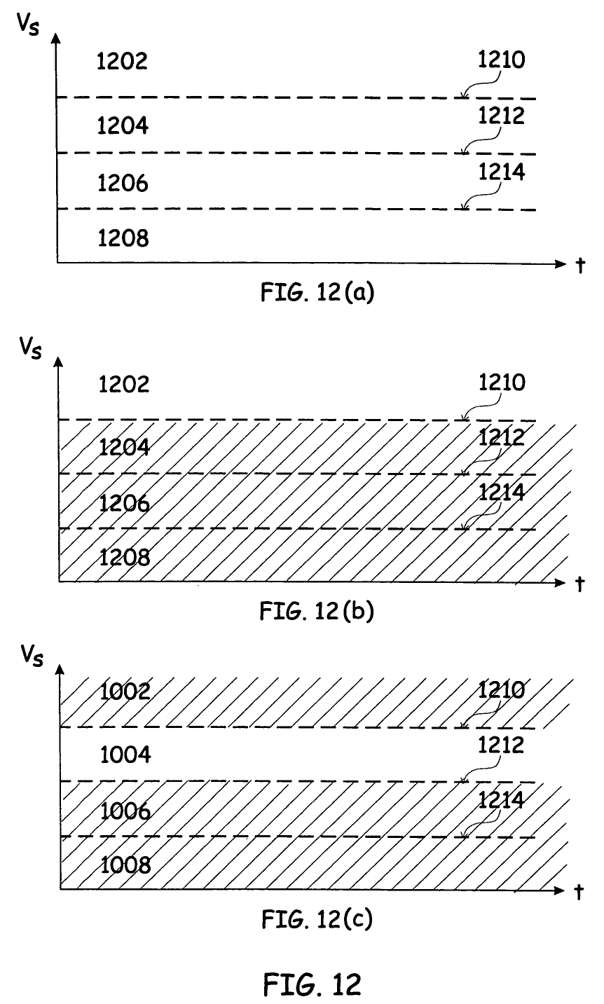

FIG. 9 shows an exemplary screen printout from an oscilloscope with the input wave 902 as a triangular wave. The corresponding output 904 is shown for a spike burster 700 with the following exemplary values; the inductor 704 is 68 millihenrys (mH), the operational amplifier 706 is National Semiconductor part number LM 358; the value of the negative feedback resistor 708 is 820 ohms; the value of the power voltage 710 to the operational amplifier 706 is 1.8 volts; the value of the positive feedback resistor 712 is 39 ohms; and the value of the ground resistor 716 is 100 ohms. The activation region 906 of the spike burster 700 is above the activation threshold 908. The deactivation region 910 is the area below the activation threshold 908. The output 904 of the exemplary spike burster may output spikes while the signal remains above the activation threshold 908 and within the activation region 906. Again, the number of output voltage spikes 904 may be limited to a known number of output voltage spikes if more than one spike burster is used, such that the particular number of spikes corresponds to a particular symbol or number. The activation threshold 908 may be raised or lowered by changing the values of the individual components as shown in FIGS. 12, 13 and 19.

FIG. 10(a) shows an exemplary embodiment of signal's-derivative-controlled activation and deactivation regions of an exemplary four spike burster receiver system of the present invention. Spike burster one's activation region 1002 includes the area above spike burster one's activation threshold 1010. Spike burster one's deactivation region includes the area below spike burster one's activation threshold 1010. Spike burster one's deactivation region includes spike burster two's activation region 1004, spike burster three's activation region 1006 and spike burster four's activation region 1008, as shown by the shaded area in FIG. 10(b). Spike burster two's activation region 1004 is between spike burster two's activation threshold 1012 and spike burster one's activation threshold 1010.

As shown by the shaded area in FIG. 10(c), spike burster two's deactivation region may include the area above spike burster one's activation threshold 1010 and the area below spike burster two's activation threshold 1012. Spike burster two's deactivation region includes spike burster one's activation region 1002, spike burster three's activation region 1006 and spike burster four's activation region 1008. Spike burster three's activation region 1006 is between spike burster two's activation threshold 1012 and spike burster three's activation threshold 1014. Spike burster three's deactivation region includes the area above spike burster two's activation threshold 1012 and the area below spike burster three's activation threshold 1014. Spike burster three's deactivation region includes spike burster one's activation region 1002, spike burster two's activation region 1004 and spike burster four's activation region 1008. Spike burster four's activation region 1008 includes the area below spike burster 3's activation threshold 1014. Spike burster 4's deactivation region includes spike burster one's activation region 1002, spike burster two's activation region 1004 and spike burster three's activation region 1006. Spike burster four's deactivation includes the area above spike burster four's activation threshold 1014.

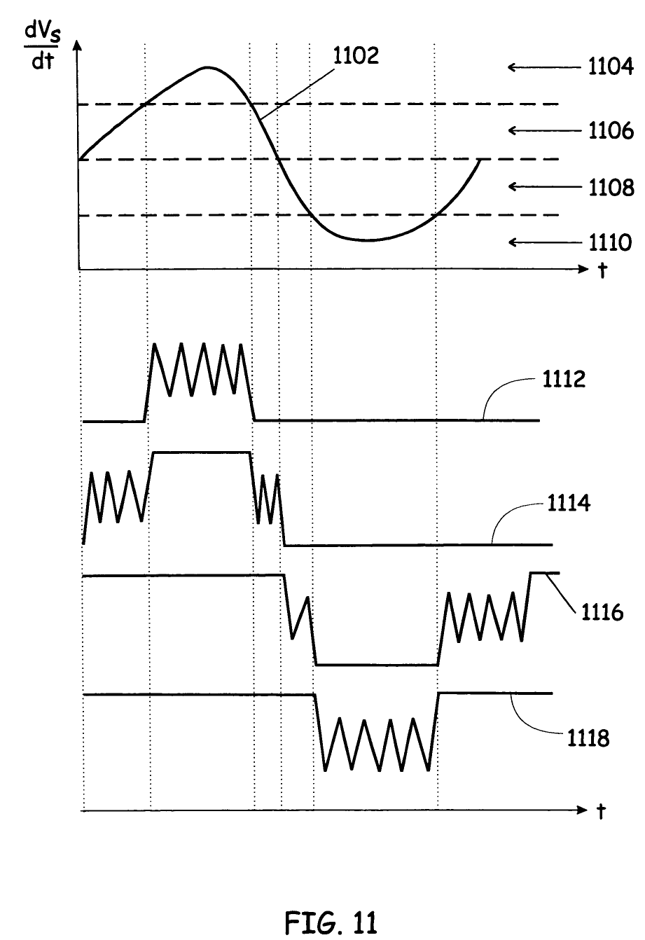

FIG. 11 shows an input wave 1102, by way of example only, in one input cycle to the four spike burster system depicted in FIG. 10(a). As the input wave is within each particular spike burster activation region 1104, 1106, 1108, 1110 each spike burster correspondingly outputs voltage spikes 1112, 1114, 1116, 1118. When the input wave 1102 is in the spike burster one's activation region 1104, spike burster one's output 1112 outputs voltage spikes. When the input wave 1102 is not in spike burster one's activation region 1104, spike burster one's output 1112 is a constant flat voltage. As the input 1102 passes into spike burster two's activation region 1106, spike burster two's output 1114 outputs voltage spikes. When the input 1102 is not in spike burster two's activation region 1106, spike burster two's output 1114 is a constant flat voltage. When input 1102 lies within spike burster three's activation region 1108, spike burster three's output 1116 outputs voltage spikes. When the input wave 1102 is not in spike burster three's activation region 1108, spike burster three's output 1116 is a constant flat voltage. Finally, when the input 1102 lies within spike burster four's activation region 1110, spike burster four's output 1118 outputs voltage spikes. When the input wave 1102 is not in spike burster four's activation region 1108, spike burster four's output 1118 is a constant flat voltage.

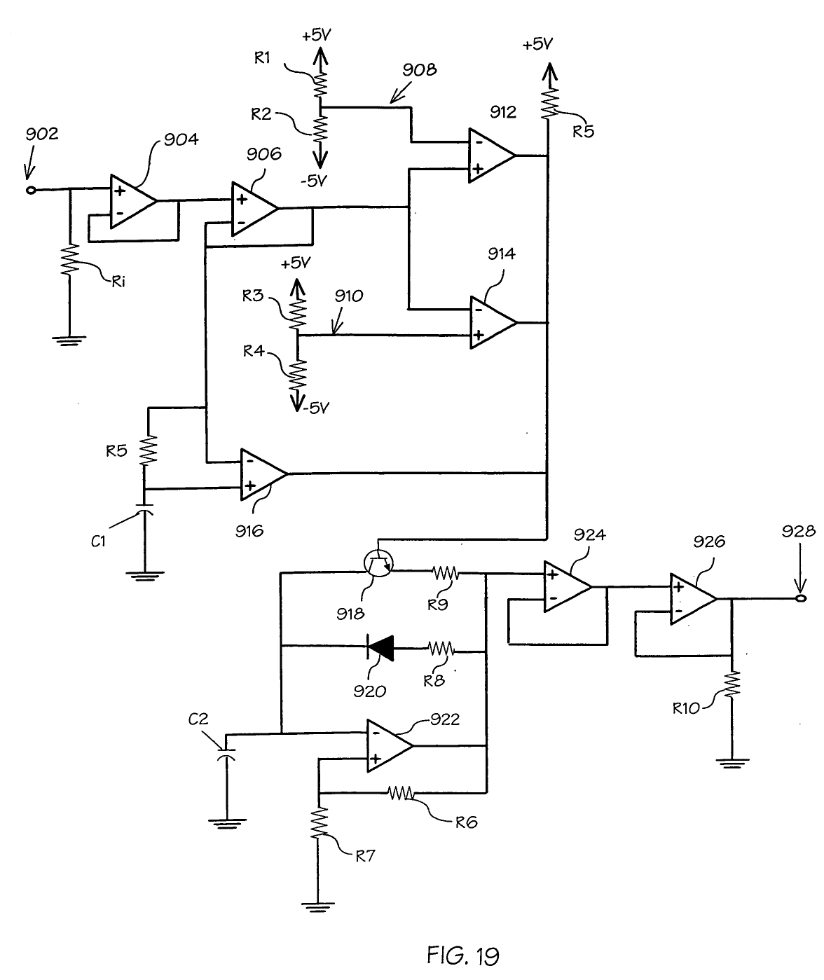

The present invention may also utilize a natural adaptive timing property. The input wave 1102 does not have to be synchronized with the spike bursters 1104, 1106, 1108, 1110. When the input wave 1102 is within a particular spike burster's activation region, that spike burster outputs voltage spikes. When the input signal starts, the output starts. Therefore, when the outputs 1112, 1114, 1116, 1118 from each spike burster 1104, 1106, 1108, 1110 may be summed using, for example, a summing operational amplifier, the data will exit the spike burster system in the same order that the data came into the spike burster system. Using the four spike burster system in FIG. 10 with four variations of the spike burster in FIG. 19, and an amplitude modulator 106 for the coder, increased bandwidth efficiency may be obtained.

FIG. 12(a) shows an exemplary embodiment of signal's-amplitude-controlled activation and deactivation regions of an exemplary four spike burster receiver system of the present invention. Spike burster one's activation region is 1202. Spike burster two's activation region is 1204. Spike burster three's activation region is 1206. And spike burster four's activation region is 1208. With the signal replacing signal's derivative in FIGS. 10 and 11, the explanation for FIG. 12 is similar to that of FIG. 10.

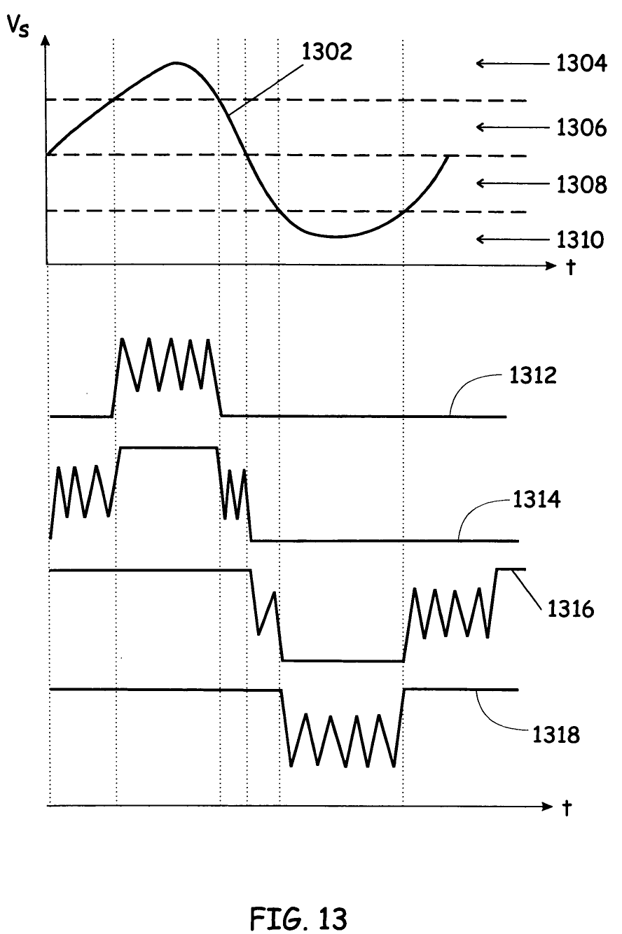

FIG. 13 shows an input wave 1302 in one input cycle to the four spike burster system depicted in FIG. 12(a). Again, with the signal itself replacing signal's derivative in FIGS. 10 and 11, the explanation for FIG. 13 is similar to that of FIG. 11.

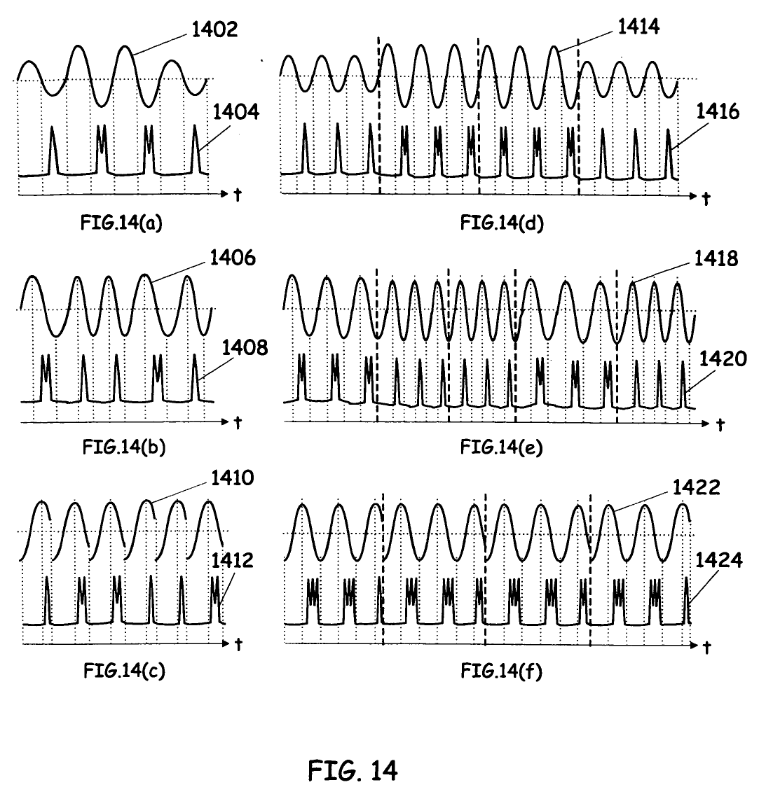

FIG. 14(a) shows an exemplary embodiment of a sinusoid signal 1402 with a fixed frequency but two varying amplitudes onto which information in symbol sequence 0110 is encoded, and an exemplary output 1404 of an amplitude-controlled spike burster of a receiver of the present invention. The spike number sequence that represents the symbol sequence 0110 is 1221 in two varying spike numbers. The output burst is in synchrony with input's change in amplitude.

FIG. 14(b) shows an exemplary embodiment of a sinusoid signal 1406 with fixed amplitude but two varying frequencies onto which information in symbol sequence 10010 is encoded, and an exemplary output 1408 of a derivative-controlled spike burster of a receiver of the present invention. The spike number sequence that represents the symbol sequence 10010 is 21121 in two varying spike numbers. The output burst is in synchrony with input's change in frequency.

FIG. 14(c) shows an exemplary embodiment of a sinusoid signal 1410 with a fixed frequency but two varying phases taking place during activation onto which information in symbol sequence 011001 is encoded, and an exemplary output 1412 of a derivative-controlled spike burster of a receiver of the present invention. The spike number sequence that represents the symbol sequence 011001 is 122112 in two varying spike numbers. Again, the output burst is in synchrony with input's change in phase.

FIG. 14(d) shows an exemplary embodiment of a sinusoid signal 1414 which is an exemplary carrier-modulated wave of the baseband signal 1402 of FIG. 14(a). Each baseband symbol cycle repeats (in an exemplary embodiment) three times on the carrier to create a modulated symbol cycle. That means the frequency ratio between the carrier cycle and the symbol cycle is 3:1. The symbol sequence 0110 is encoded with two varying modulated amplitudes. An exemplary output 1416 of an amplitude-controlled spike burster of a receiver of the present invention shows a spike number sequence representation 111222222111 with each symbol repeatedly decoded three times, the ratio of carrier frequency to symbol frequency. By decoding a given symbol many times over, errors due to system distortions other than information source error may be detected and corrected. This redundancy is the basis of error detection/correction attribute built into the communication method of the present invention. Also, output bursts are in synchrony with the modulated signal cycles.

FIG. 14(e) shows an exemplary embodiment of a sinusoid signal 1418 which is an exemplary carrier-modulated wave of the baseband signal 1406 of FIG. 14(b). Each symbol cycle repeats (in an exemplary embodiment) three times on the carrier. The symbol sequence 10010 is encoded with two varying modulated frequencies. An exemplary output 1420 of an derivative-controlled spike burster of a receiver of the present invention shows a spike number sequence representation 222111111222111 with each symbol repeatedly decoded by the same number of times as the ratio of carrier frequency to symbol frequency. Again, similar to FIG. 14(d), errors due to system distortions other than information source errors can be detected and corrected. Also, output bursts to modulating cycles are in synchrony.

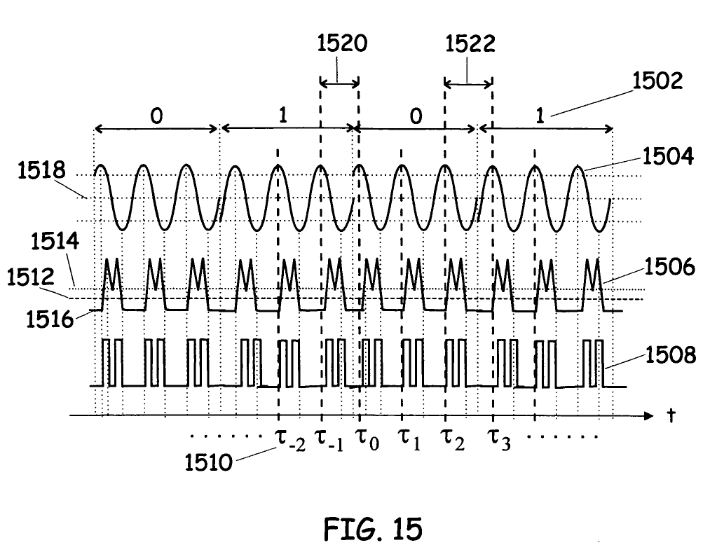

FIG. 14(f) shows an exemplary embodiment of a sinusoid signal 1422 which is an exemplary carrier-modulated wave of the baseband signal 1410 of FIG. 14(c). Unlike the cases of FIGS. 14(d), each symbol represented by varying phase does not repeat with the carrier. For the symbol sequence 011001 carried by the signal, the spike number sequence representation is 331332332331 . . . by an exemplary output 1424 of a derivative-controlled spike burster of the present invention. Each symbol is not decoded redundantly by counting spike number. However, it may be decoded redundantly by an exemplary technique (FIG. 15) wherein the starting time of each burst is used for redundancy symbol decoding. Again, output bursts to modulating cycles are in synchrony.

FIG. 15 shows an exemplary embodiment phase-modulated sinusoid input signal 1504 and two exemplary spike burst outputs 1506, 1508 of a derivative-controlled spike burster(s) of a receiver of the present invention. The sinusoid carrier has a fixed frequency with cycle period denoted by T₀. The burst activation threshold for a signal 1504 to enter an activation region is exemplarily set at the point its slope changes from positive to negative, that is, at the point the signal 1504 reaches its maximum value. The burst deactivation threshold for a signal 1504 to enter a deactivation region is exemplarily set at the minimum point of the signal 1504 (although it is not necessary to set either point at a special location).

Signal 1504 encodes an exemplary symbol sequence 1502 with 0 and 1 for the symbols. Each symbol is represented by a phase-modulated wave. One full carrier cycle is set to start at the zero voltage level 1518 in upward moving direction and to end at 1518 in an upward moving direction as well. Output bursts to carrier cycles alone are synchronized periodically T₀ period apart. Symbol 0's wave is constructed by deleting a signal segment of a₀ fraction of the period T₀ in time length from a waveform of 3 full carrier cycles. If 0<a₀<1/4, symbol 0's wave results in an advance of burst activation by the amount of a₀*T₀ in time. In other words, the two consecutive and transitional burst activation times are shortened by a₀*T₀ units in time such as 1520. FIG. 15 is the case with a₀=1/8. On the other hand. Symbol 1's wave is constructed by adding a signal segment of d₀ fraction of the period T₀ to a waveform of 3 full carrier cycles. If 0<d₀<1/4, this symbol wave results in a delay in burst activation by the amount of d₀*T₀ in time. In other words, the two consecutive and transitional burst activation times are lengthened by d₀*T₀ units in time such as 1522. FIG. 15 illustrates d₀=1/8. With 1/4<a₀<1/2 and/or 1/4<d₀<1/2, corresponding burst activation shifts may also be obtained similarly. Output waves of 1504 and 1506 may, for example, either be two different outputs in voltage or current of one spike burster or two different outputs of two distinct spike bursters. Denote the burst initiation moment that the signal 1504 crosses the burst activation threshold by . . . τ₋₂, τ₋₁, τ₀, τ₁, τ₂ . . . 1510 with τ₀ the most present moment, τ₋₁ the moment before τ₀ and τ₁ the moment after τ₀, and so on. Each burst initiation moment, τⱼ, may be determined from spike burster outputs 1506, 1508 either by a voltage threshold counter or by a cycle timer. For example, a voltage threshold 1512 may be preset between the minimum value of the spikes 1514 and the near-constant deactivation voltage 1516. Then burst initiation time τⱼ may be defined as an average of a time interval during which the output 1506 swings upwards and crosses the voltage threshold 1512. As for output type 1508, the burst initiation time τⱼ may be defined to be an average moment that the output 1508 becomes active in spiking after a preset long pause of staying near-constant deactivation voltage.

Having the burst initiation time sequence . . . τ₋₂, τ₋₁, τ₀, τ₁, τ₂ . . . 1510 enables the receiver to decode each symbol by a preset number of time. For the exemplary phase-shift-keyed sinusoid signal 1504, symbol 0's waveform advances the next burst by 1/8 of the carrier period in length, and symbol 1's waveform delays the next burst by 1/8 of the carrier period in length. Therefore, the time lapse between consecutive burst initiation times, τⱼ-τⱼ₋₁, is exactly the period of the carrier (8/8 T₀) if it does not occur during a transition between symbols. The time lapse is correspondingly 7/8 of the carrier period for symbol 0 and 9/8 of the carrier period symbol 1 respectively. Having this burst time lapse sequence {τⱼ-τⱼ₋₁} requires the receiver to remember the last burst initiation time τⱼ₋₁, (a 1-memory receiver). The burst time lapse sequency {τⱼ-τⱼ₋₁} will exhibit the following exemplary pattern for the symbol sequence . . . 0101 . . . , using 1/8 of the carrier period as the unit of time,
. . . 7 8 8 9 8 8 7 8 8 9 8 8 . . .
   However, if the decoder uses a 2-memory burst time lapse sequence {τⱼ-τⱼ₋₂}, the sequence will exhibit the following exemplary pattern for the same symbol sequence, using 1/8 of the carrier period as the unit of time as well,
. . . 15 15 16 17 17 16 15 15 16 17 17 16 . . .
   With such an exemplary 2-memory decoder, each symbol is decoded twice. Similarly, a 3-memory burst time lapse sequence {τⱼ-τⱼ₋₁} looks like
. . . 23 23 23 25 25 25 23 23 23 25 25 25 . . .
   decoding each symbol three times in repetition. In general, with a k-memory decoder or the like, so long as k is not greater than the ratio of the carrier frequency to the symbol frequency, then each symbol may be decoded k times redundantly. The signal symbol is in synchrony with burst lapse sequences.

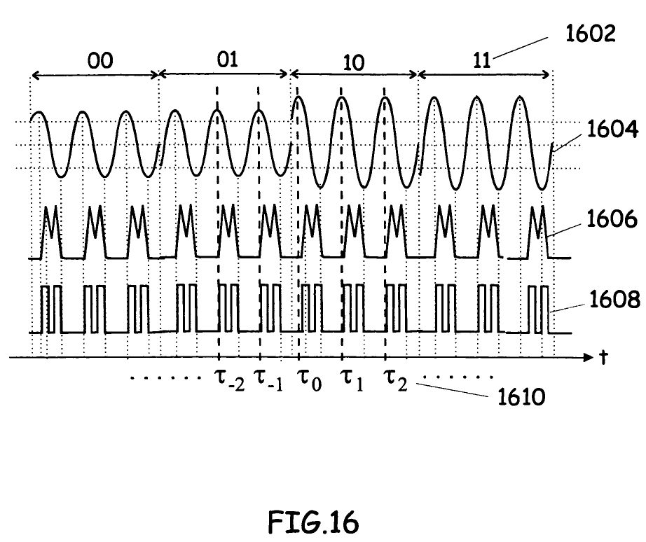

FIG. 16 shows an exemplary phase and amplitude modulated sinusoid input signal 1604 and two exemplary spike burst outputs 1606, 1608 of a derivative-controlled spike burster(s) of a receiver of the present invention. Output waves 1604 and 1606 may either be two different outputs in voltage or current of one spike burster or two different outputs of two distinct spike bursters. The activation threshold for the signal 1604 to enter the activation region is exemplarily set at the points its slope changes from positive to negative, and the deactivation threshold is set at the minimum points of the signal, all similar to FIG. 15. The signal 1604 encodes an exemplary symbol sequence 1602. Each symbol is a string of two digits in 0 and 1: 00, 01, 10, 11. Each symbol carries two bits of information. The first digit (counted from the right most place, e.g., 0 is the first digit of the symbol 10) is represented by a phase shift of the modulating sinusoid carrier of a fixed period T₀. Digit 0 has an advance shift in burst activation by the amount of 1/8 the carrier period in time, and digit 1 has a delay shift in the burst activation by the amount of 1/8 the period in time.

The second digit (e.g., 1 of the symbol 10) is represented by an amplitude shift of the modulating sinusoid carrier, with the low amplitude for 0 and the high amplitude for 1. Denote the burst initiation moment that the signal 1604 crosses the activation threshold by . . . τ₋₂, τ₋₁, τ₀, τ₁, τ₂ . . . 1610 with τ₀ the most present moment, τ₋₁ the moment before τ₀ and τ₁ the moment after τ₀, and so on. Each burst initiation moment, τⱼ, may be determined from spike burster outputs 1606, 1608 either by a voltage threshold counter or by a cycle timer similar to FIG. 15, 1512, 1514, 1516. Thus, similar to FIG. 15, the phase shifts of the carrier in burst activation may be detected and the first symbol digit can be decoded. Shifts in carrier amplitude may be detected by either amplitude envelope techniques or by amplitude-controlled spike bursters in addition to the phase shift detecting, derivative-controlled spike bursters. Together, each symbol can be decoded, and each can be synchronized with its corresponding burst initiation time.

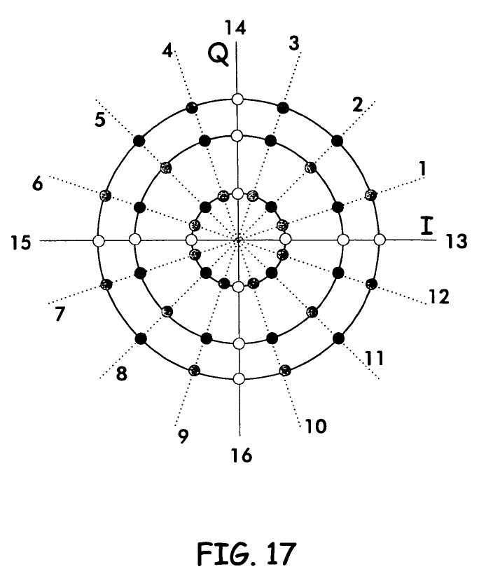

FIG. 17 is an exemplary 16 state-point (data point) quadrature polar coordinate diagram. This diagram shows the 16 available quadrature data points in black circles. These quadrature points occupy one of the 12 phases and 3 amplitude rings. FIG. 17 also shows an additional set of non-quadrature points which share the same phase and amplitude as the various quadrature points. There are an additional 20 non-quadrature data points available under a preferred embodiment in this example of the present invention (FIG. 17, grey circles). This provided a bandwith efficiency gain over the quadrature points alone (ln36/ln2=5.17 bits/s/Hz). Additionally, the diagram also shows an additional 12 corresponding data points (FIG. 17, white circles). These corresponding data points both lie on the same amplitude rings as the quadrature points and their phase differences are comparable to the phase differences between quadrature points. By adding these corresponding data points a bandwith efficiency gain may be provided (ln48/ln2=5.85 bits/s/Hz).

For example, telephone modems utilize quadrature modulation with M-ary signaling. The signal may take the form I*cos(ωt)+Q*sin(ωt) with I the in-phase component and Q the quadrature component, and ω/2*π the carrier frequency. With M states, each state point (Iⱼ,Qₖ),j=1,2, . . . , m₁; k=1,2, . . . , m₂; and m₁*m₂=M) carries r=ln(M)/ln2 bits of information, and the bandwidth efficiency factor is r bits/s/Hz. We may rewrite the signal form into I*cos(ωt)+Q*sin(ωt)=A*cos(ωt−P) with A=sqrt(I²+Q²), tan(P)=Q/I. A as the amplitude and P as the phase shift. Therefore, the M states (Iⱼ,Qₖ) in terms of the phase shift P_{{jk}} with tan(P_{{jk}})=Qₖ/Iⱼ, and the amplitude A_{{jk}}. Thus, for large M, there usually are more than sqrt(M) distinct phases P_{{jk}} and more than sqrt(M) amplitude A_{{jk}}. Denoting the number of distinct phase by Nₚ and the number of distinct amplitude by Nₐ. The foregoing analysis provides
Nₐ>sqrt(M) and Nₚ>sqrt(M)
and the total number of state points in A and P [(A,P)-state points], of which the quadrature points are a part is
L=Nₐ*Nₚ>sqrt(M)*sqrt(M)=M.

Stated differently, each quadrature point occupies a spot in the phase-amplitude constellation (A,P), but there are more (A,P)-state points not occupied by an M-ary quadrature point. Moreover, an (A,P) state point which is not a quadrature point gives rise to the same signal characteristics as a quadrature does, in particular, in terms of the signal to noise ratio. This means, if the channel allows a quadrature-point signal through, it should allow a non-quadrature (A,P)-state signal through as well. All (A,P)-state signal may also pass through the channel. Also, if two quadrature points are distinguishable at the receiver, so are their amplitudes and phases. Therefore, two (A,P)-state points should be distinguishable at the receiver as well because they share the same amplitude and phases as various quadrature points. The present invention may be utilized to capture these (A,P)-state points (orphan points). Thus, allowing for an increase in the bit efficiency factor (R=ln(L)/ln2 bits/s/Hz) and the gain factor over the quadrature efficient factor
R/r=ln(L)/ln(M).

Using conventional Fourier methods to recover the quadrature point (I,Q) does not necessarily recover the phase P=tan⁻¹(Q/I). Since doing division Q/I or I/Q is tricky, as I, Q may be very small, and round-off errors may be overwhelming, the present invention preferably measures the phase shift of the signal (FIGS. 15 and 16). The practicable measurability is improved by the spike burster of the present invention. The phase shift of the input signal to a derivative-controlled spike burster causes a time shift in the burst activation of the output.

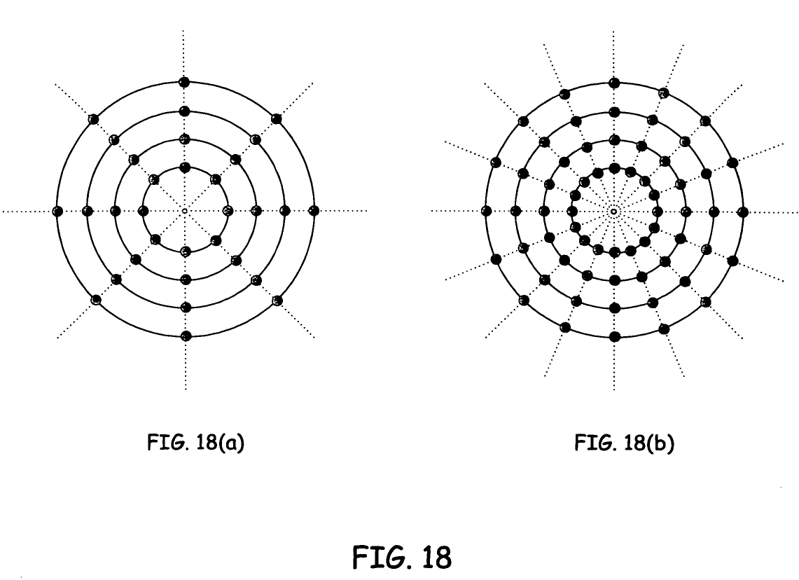

FIG. 18 shows two exemplary (A,P)-state point constellations. In FIG. 18(a), there are 4=2² amplitude rings spaced apart equally and 8=2³ phase rays also spaced apart equally. In an exemplary embodiment, each gray point (data point) carries 5 bits of information. We may determine the amplitude A and phase shift P of a symbol signal A cos(ωt−P) (1604, FIG. 16). In terms of the polar coordinate (A,P), the direction of the phase is along the concentric amplitude circles and the direction of the amplitude is along the equal-phase rays. These directions are orthogonal and representing symbols by varying amplitudes and phases of the sinusoid signal is an example of orthogonal signaling, given that quadrature amplitude modulation is another example of orthogonal signaling. This means that on two distinct rays the phase distance between two points from an inner amplitude ring is the same as two points from an outer amplitude ring. However, in terms of their in-phase and quadrature point signaling, the inner ring points are much closer to each other than the outer ring points. Thus, a quadrature modulation/demodulation scheme which is able to distinguish outer ring (A,P)-points may not necessarily be able to distinguish inner ring (A,P) data points. In other words, which signal characteristics a particular method chooses to measure should strongly effect the method's utilization of bandwidth. The present invention measures the phase and amplitude independently. Inner ring points are spaced equally apart in phase as outer ring points. Their differences are only in varying amplitude.

FIG. 18(b) is another (A,P)-point constellation which may be utilized by the present invention. There are 4=2² equally spaced amplitude rings and 16=2⁴ equally spaced phase rays. Each data point carries 6 bits of information. Compared to the 16-QAM constellation of FIG. 17 (black points), the signal characteristics are comparable. However, each of the 16-QAM point carries only 4 bits of information. The efficiency gain is (6−4)/4=50%.

FIG. 19 depicts an exemplary embodiment of a circuit which may be utilized as the spike burster portion in an embodiment of the present invention. By adjusting the values of the individual components in the circuit, the activation region and deactivation region of the spike burster may be adjusted. The input 902 is where the transmitted input signal(s) enter the spike burster circuit. The input resistor, Ri, provides impedance control appropriate for the input signal used in the application.

Operational amplifiers 904. 906 are used as voltage followers to buffer the input signal and limit loading on the input line 902. This allows the impedance to be completely defined by the input resistor, Ri. Since the operational amplifiers are inverting buffers, two are used to return the correct input signal. These operational amplifiers 904, 906 could be National Semiconductors part number LM 1458. The next operational amplifiers 912, 914 are part of a comparator that sets the active range of the spike burster. The use of this comparator provides control over the upper and lower limits of the spike bursting activity. National Semiconductor part number LM 393 could be used for these operational amplifiers 912, 914. These operational amplifiers (912, 914) usually have their outputs pulled high in operation. This allows for several such comparators to be cascaded as has been done in this circuit. The circuit may be powered by +5 volts and −5 volts as shown at various points in the circuit. This allows for positive and negative input signals to be used entering the circuit at 902. The lower threshold voltage. Vₗₜ, 908 is defined by the power voltage range multiplied by a particular ratio of the lower threshold resistors R1 and R2. Vₗₜ 908 is defined by the circuit as
Vₗₜ=+5−(−5)*(R2/(R1+R2)+(−5).
Therefore, the lower threshold voltage, Vₗₜ 908, may be positioned by a particular ratio of R2/(R1+R2) multiplied by the power voltage. For instance, if R2 was very large in comparison to R1, the ratio of R2/(R1+R2) would be nearly 1 which would make the lower limit voltage Vₗₜ 908 very close to 5 volts. If R1=R2 then the lower threshold voltage Vₗₜ 908 would be 0 volts. If R2 were 0, then the lower threshold voltage Vₗₜ 908 would be −5 volts. The upper threshold voltage Vᵤₜ, 910 is then defined as a particular ratio of the upper threshold resistors R3, R4 multiplied by the power voltages +5 and −5 volts. The particular ratio is defined as
Vᵤₜ=+5−(−5)*(R4/(R3+R4))+(−5).
Therefore, the upper limit voltage Vᵤₜ 910 may, be manipulated by the same changes in R3 and R4 as were shown with the lower threshold voltage Vₗₜ 908, using R1 and R2. The operational amplifier 916 acts as a derivative detector circuit. It detects the negative slope of the analog input waveform. It does this by imposing a lag time on the input to the circuit, R5 and C1 define the lag time coefficient
τ=R5*C1.
The lag time coefficient τ should be less than 1% of the period of the analog waveform to insure that the spike burst occurs in a timely manner. Therefore, on the rising portions of the input waveform, the positive input will always be less than the negative input. This keeps the output of the operational amplifier 916 low, thereby disabling the transistor 918. This also keeps the rest of the circuit from outputting spike bursts. If the input signal voltage entering the circuit at 902 is greater than the lower threshold limit Vₗₜ 908 and less than the upper threshold limit Vᵤₜ 910, and the signal has a negative slope, the comparator will enable the spike burster through the transistor 916. In the exemplary embodiment, the resistor R5 was set at 500 ohms so that the signal traveling to the transistor 916 is TTL or CMOS compatible. The spike burster operational amplifier 920 is part of the circuit that functions as a variable duty multivibrator or spike burster.

When enabled, the amplifier 920 outputs a pulse stream or spike burst. The NPN transistor 916 enables or disables the rest of the circuit. The part of the circuit below the transistor is very much like the spike burster in FIG. 4. So the transistor 916 enables or disables the spike burster. The transistor 916 could be a National Semiconductor part number 2N2222. The positive feed back resistor, R6 and the positive feedback to ground resistor R7 set the multivibrator threshold. For simplicity we set R6=R7. The ratio between the negative feedback resistor R8 and the transistor resistor R9 sets the duty cycle output from the multivibrator. Setting R8=R9 creates an equal on and off cycle for the spikes within the spike burst stream. The transistor 916 and the diode 918 control the charge and discharge cycles for the capacitor C1. These components, along with R8 and R9 control the on and off times for the multivibrator. The diode 918 and R8 assures that there will be no partial spikes outputted. The on time Tₒₙ, for the multivibrator is defined by
Tₒₙ=R8*C1*ln(1+((2*R6)/R7).

Since Tₒₙ is the cycle time, the frequency of the spike bursts is 1/Tₒₙ. The off time T_{off}, of the multivibrator is defined by
T_{off}=R9*C1*ln(1+((2*R6)/R7).
Therefore, if R8=R9, then the multivibrator will have an equal on and off time. If the transistor is turned off, then the transistor resistor R9, effectively becomes infinite and T_{off} therefore becomes infinite and the multivibrator remains disabled. The last pair of operational amplifiers 924, 926 form another pair of voltage followers as did 906 and 908, and function as a buffer pair. This again limits the load on the output of the spike burster operational amplifier 922.

Again, two are used to get the correct sign on the signal as it travels out of the circuit. The output impedance resistor R10 sets the output impedance for the spike burster. The value of R10 must be coordinated with the circuitry downstream from the spike burster. The output of spike bursts exits the circuit at 928. So using this circuit, the lower threshold voltage Vₗₜ 908 and the upper threshold voltage Vᵤₜ 910 can easily be set as shown in FIGS. 10 and 11. By using more than one spike burster, the various different activation regions can be created as in FIGS. 10 and 11.

The output is evenly spaced apart spikes because of R8=R9, and there are no partial spikes because of the diode 918 and the resistor R9. A counter such as Texas Instruments part number 74HC4040 may be used to count the spikes and output the number of spikes counted to a processor, thereby completing the decoding of the transmitted signal.

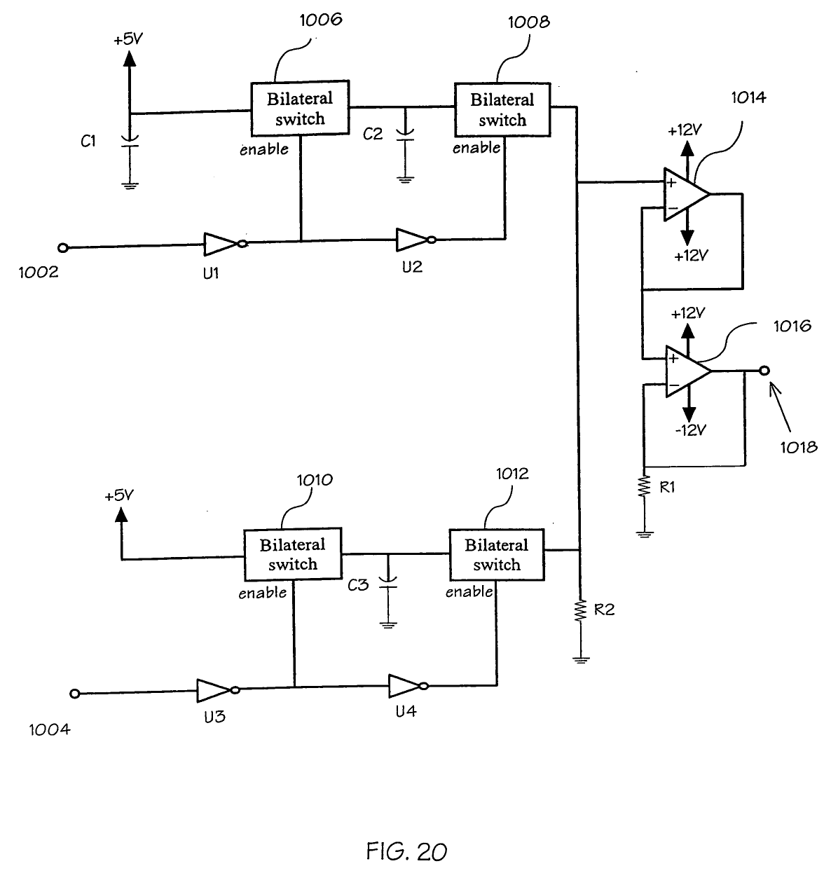

FIG. 20 depicts an exemplary embodiment of a circuit that may be used as a coder for the present communication system. The first capacitor C1 separates this circuit from the rest of the system and provides instantaneous charge current for circuit operation. This circuit takes digital inputs at 1002 and 1004. Low voltage or “0” should be inputted at 1002 and high voltage or “1” should be inputted at 1004. The bilateral switches will transfer an analog or digital signal bidirectionally regardless of polarity once the switch is enabled. The enable connection for the bilateral switch is shown in the figure at the bottom of each switch. When the enable is activated the switch will transfer a signal bidirectionally. The invertors 1006, 1008, 1010, 1012 are used to enable the switched 180 degrees out of phase with each other. When switch 1006 is enabled, switch 1008 is disabled. When switch 1008 is enabled, switch 1006 is disabled. The same applies for switches 1010 and 1012. Bilateral switch 1006 controls the charging of the capacitor C2. Bilateral switch 1010 controls the charging of the capacitor C3. The capacitor C1 should be much greater than the values of C2 and C3. The bilateral switch may be Texas Instruments part number 74HC4066. Capacitors C2 and C3 should have different values as this will affect the amplitude of the outgoing analog wave. The greater the value of the capacitor, the greater the amplitude of the outgoing wave. In this way the amplitude of the analog wave corresponding to a “0” will be different (lesser) than the amplitude of the analog wave corresponding to a “1” (greater).

Whenever C2 or C3 is not being discharged, it is being charged and prepared for its next discharge cycle. This allows the piecewise assembly of an analog waveform that corresponds to the 0's and 1's of the input digital wave. Once C2 and C3 are charged, the circuit can be forced to discharge either C2 or C3 to ground through the resistor R1 by either inputting a 0 or 1 in at 1002 and 1004 respectively. This circuit will also take inputs of neither a 1 or a 0 or both.

Therefore, this circuit may encode up to 4 different logic numbers, 00, 0, 1, and 01. Circuits similar to the one depicted in FIG. 19 may be designed to decode all four of these different type of bits, thereby increasing the data rate without increasing bandwidth. The operational amplifiers 1014 and 1016 again form a buffer that allows the output impedance to be defined by R2. The operational amplifiers may be National Semiconductor part number LM1458. The power to these amplifiers should be plus and minus 12 volts so that the output wave will not be clipped. The output of this circuit exits at 1018. The output of this circuit will look similar to a saw-tooth waveform. The capacitors will charge rapidly and discharge at a rate according to the equation
T_{d}=5e^{-(t/(50+R2)*C2)}
for the portion of the coder that codes the digital 0, where T_{d} is the discharge time.

Therefore, the discharge time of the capacitor is directly proportional to the value of the capacitor. Therefore, the amount of time it takes for the output analog signal to discharge from peak voltage to a steady low voltage depends directly on the size of the capacitor C2. In this way the amount of time the output analog signal spends in a particular activation region can be controlled by the sizes of the capacitors used in this circuit. The same may be done for the portion of the circuit that creates the analog signal that corresponds to the digital 1 by varying the value of C3. The circuit in FIG. 19 will output spikes while the analog wave from this circuit has a negative slope and is within the particular activation region of a circuit similar to the one in FIG. 19. Even in this simple example, more than one bit per wavelength is achieved if the analog wave outputted from this circuit is allowed to descend through more than one activation region of circuits like the one in FIG. 19.

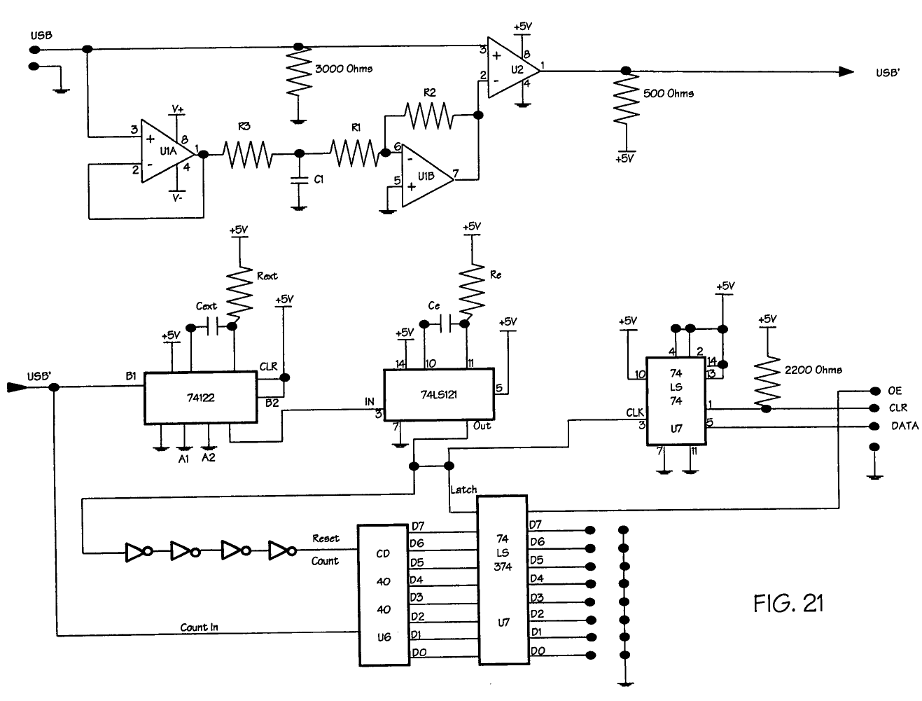

FIG. 21 is a schematic of an adaptive counter circuit which may be utilized in a preferred embodiment of the present invention. The input to U1A is the USB signal. In an exemplary embodiment the waveform represents a three spike burst. It is not ground referenced and the characteristics of the individual pulses are arbitrary for illustrative purposes only. U1A is an inverting unity gain buffer which acts to prevent the circuit from distorting the waveform. This preserves the purity of the waveform. R₃ and C₁ function as an averaging circuit. The change on C₁ provides a rolling average of the inverted signal. A representation of the change on C₁ follows. Note, the sense of this voltage is an inversion from the incoming signal. This voltage is also utilized later for comparison. The first part of this circuit cleans up an analog signal and ground references it, later converting it to a TTL compatible logic signal, U1B is an inverting amplifier. Two inversions put the signal back on the positive side of ground. The gain of this amplifier is held to about −1.1. This provides a slight offset from the actual average. This is done to prevent false triggering in the comparator. It raises the reference voltage slightly.

The output from the comparator is a ground referenced TTL compatible logic signal. It takes the form of a series of pulses with amplitudes of nearly five volts. This becomes the USB′ signal that is fed back into U3, the retriggerable monostable multivibrator. The retriggerable feature is important because it allows the counter to be adaptable. U3 retriggers on each pulse. It times out after waiting 150% of a gap width. The Q output then drops to a low level. The Q signal rises at the end of the time out period. This signal is fed to U4, U4 is sensitive to the rising edge of the signal, U4 is also a monostable multivibrator but it is not retriggerable, U4 output is a very narrow pulse. The USB′ pulse train has been fed to the counter U6, U6 is a twelve stage ripple counter. This pulse, the output of U4, latches the count to U5 from U6. This pulse also sets the data flag “DATA” by latching the flip flop U7.

U8 is an inverter pack and is used here to provide a propagation delay. After being delayed, the pulse resets the counter, in preparation for the next burst. The delay prevents resetting the counter before the count is latched to the register U5. Thus, it protects the validity of the count.

In practice, the USB signal is fed to the input. The “DATA” line is tied to a processor interrupt line. The presence of data interrupts whatever processor is monitoring this circuit. That processor reads data on lines D₀→D₇ by pulling the “OE” line low. It does this in its interrupt handling routine. After reading the data, it clears the data flag by pulling the “CLR” line low. The D₀→D₇ bus is eight bits wide and conveniently interfaces with a processor bus. The “OE”, “CLR” and “DATA” lines provide the necessary handshaking for the interface. The circuit can be adjusted by changing the timing resistors and capacitors. R₃ and C₁ control the timing of the averaging circuit. Basically, this is done with the consideration that τ=RC where R is in Ohms and C is in Farads. The units of τ are seconds.

R_{PXT} and C_{PXT} on U3 control the timeout period for the multivibrator by the equation t_{w}=0.37 RC. T_{w} should be set to 150% of the longest gap width between pulses. In a present exemplary embodiment this circuit is currently wired for 0.001 sec pulses and gaps.

R_{P} and C_{P} on U4 provide the width of the latching pulse. Current component choices have set this pulse width to be 100 nsec. The pulse width is given by the equation T_{w}=0.7 RₑCₑ.

U8 provides a propagation delay. A series of four inverters provides this delay. An even number of inverters was chosen to preserve the logical sense of the pulse. A delay of about 14 nsec per gate is assumed. The inverter string, then, provides a delay of 56 nsec.

The present invention provides a method of communication that may increase data rates without a corresponding increase in bandwidth. More than one spike burster may be used to decode a signal. A spike burster's activation region is determined by the circuitry of the particular spike burster. These spike bursters may be designed such that each spike burster has a separate and distinct activation region, and all activation regions together cover the entire region in which the transmitted signal may lie. Each spike burster may output a predetermined number of voltage spikes when the transmitted wave is within the spike burster's activation region. Preferably, voltage spikes may only be outputted by one spike burster at a time. The voltage spikes from the individual spike bursters may be added together, creating distinct, separate spike burst patterns in a voltage spike signal. Then, a digital signal may be created from the pattern of voltage spikes (or their time shift in burst activation). In this way, more than one bit per wavelength may be transmitted and decoded. Therefore, more data may be transmitted and decoded utilizing essentially the same amount of bandwidth.

The present invention provides a secure method of communication by coding a spike number by a seemingly arbitrary signal going through arbitrarily preset activation and deactivation regions of a spike burster (FIGS. 2, 3, 8, 9). It may also do so by coding the activation bursts with arbitrarily preset activation and deactivation thresholds of a spike burster. The present invention gives rise to a method of communication which may measure the phase shift of a modulated sinusoid signal by timing the bursts from an output of a spike burster (see, e.g., FIGS. 15 and 16). Such a method may detect orphan data points of a QAM constellation as in FIG. 17, or data points of an (A,P)-constellation as in FIG. 18. This facilitates bandwidth efficiency where signal characteristics are comparable to a QAM constellation of a smaller number of states. The present invention provides a method of communication which may be utilized to reduce transmission error rate. This may be accomplished by making use of a modulated sinusoid carrier for redundant symbol retrieving as illustrated (FIGS. 14, 15, and 16). The present invention also provides a method of control which may use spike burster's input-output control methodology for purposes of synchronization, error detection/correction, data storage, pattern recognition, image segmentation, artificial intelligence of neural networks.

It is believed that the present invention and many of its attendant advantages may be understood by the foregoing description, and it will be apparent that various changes may be in the form, construction, and arrangement of the components thereof, without sacrificing all of its material advantages. The form herein described being merely an explanatory embodiment thereof, it is the intention of the following claims to encompass and include such changes.

1.-9. (canceled)

10. A method of increasing bandwidth efficiency in a quadrature amplitude modulation system having a plurality of quadrature points, comprising:
(a) determining a phase angle and an amplitude of a plurality of quadrature points; and
(b) deriving a plurality of orphan quadrature points by at least one (i) selecting non-quadrature points sharing at least one of the same phase angle and the same amplitude as a quadrature point, and (ii) selecting non-quadrature points having a phase angle not defined by a quadrature point but comparable to the phase angle difference between quadrature points having different adjacent phase angles and having amplitudes comparable to said quadrature points.

11. The method of claim 10 wherein said amplitude sqrt( aᵢ²+bⱼ²) and phase tan^{31 1}(bⱼ/aᵢ) are located according to the following expression:
s(t)=(sqrt(aᵢ²+bⱼ²)(cox(ωt−tan⁻¹ bⱼ/aᵢ)),
wherein the in phase component is aᵢ and the quadrature component is bⱼ according to the following expression:
s(t)=aᵢ cos ωt+bⱼ sin ωt.

12. A method of increasing bandwidth efficiency in an amplitude-phase modulation system, comprising:
(a) defining an amplitude-phase constellation as a plurality of generally equally spaced apart phase rays having a generally uniform phase angle, said phase rays orthogonally separated by a plurality of generally uniformed spaced apart amplitude rings; and
(b) deriving a plurality of amplitude-phase state points relative to the intersections of said phase rays and said amplitude rings.

13. The method of increasing bandwidth of claim 12, wherein said amplitude-phase constellation has at least four phase rays and at least two amplitude rings.

14. The method of increasing bandwidth of claim 12, wherein said amplitude-phase state points are derived according to the following expression:
s(t)=(sqrt(aᵢ²+bⱼ²)(cos(ωt−tan⁻¹ bⱼ/aᵢ)),
wherein the in phase component is aᵢ and the quadrature component is bⱼ according to the following expression:
s(t)=aᵢ cos ωt+bⱼ sin ωt.

15.-17. (canceled)
